(19) United States
(12) Patent Application Publication
(10) Pub. No.: US 2002/0036774 A1
(43) Pub. Date: Mar. 28, 2002

(54) Apparatus and method for handling and testing of wafers

(76) Inventors: Emil Kamieniecki, Lexington, MA (US); Jeffrey Sauer, Danvers, MA (US); Jonathan Fleming, Acton, MA (US); Krzysztof Kamieniecki, Cambridge, MA (US); Charles R. LeMay, Atkinson, NH (US)

Correspondence Address: BROMBERG & SUNSTEIN LLP, 125 SUMMER STREET, BOSTON, MA, 02110-1618, US

(21) Appl. No.: 09/915,200

(22) Filed: Jul. 25, 2001

Related U.S. Application Data
(60) Provisional application No. 60/223,838, filed on Aug. 8, 2000.

(51) Int. Cl. G01N 21/01

(52) U.S. Cl. 356/244

(57) ABSTRACT

Embodiments provide an apparatus and method permitting the handling of a semiconductor wafer while maintaining the vacuum applied to the relevant wafer handling equipment continuously in an actuated state. These embodiments provide more gentle wafer handling with reduced contamination risk. One embodiment provides a passive end effector. Another embodiment provides a holder, for an object such as a semiconductor wafer, that utilizes Bernoulli-type forces to retain the object against the holder.

### RELATED APPLICATION

The present application claims priority from U.S. provisional application Ser. No. 60/223,838, filed Aug. 8, 2000, for an invention of Emil Kamieniecki, Jeffrey Sauer, Jonathan Fleming, Krzysztof Kamieniecki, and Charles R. LeMay, entitled Method and Apparatus for Holding an Object.” This related application is hereby incorporated herein by reference.

### TECHNICAL FIELD

The present invention relates to apparatus and methods for handling of semiconductor wafers, more particularly for testing purposes.

### BACKGROUND ART

In numerous areas of high and low technological application, fragile objects must be handled for purposes of transport and holding in place while minimizing undue risk of breakage, warpage, and contamination. Varying degrees of sophistication and innovation in, for example, vacuum, magnetic, and electrostatic fixturing have led to considerable advances in non-contact or minimal contact transport and holding devices. Contamination remains a continuing problem area.

Representative systems in the prior art for handling semiconductor wafers for testing purposes are shown in U.S. Pat. Nos. 4,695,215; 4,907,931; 5,479,108 (the “'108 patent”); and U.S. Pat. No. 6,249,342. It is common to use an end effector (such as wand 62 shown in the '108 patent) to move a wafer between a first location, such as a cassette (for example, cassette assembly 18 in the '108 patent), and a test chuck (such as chuck 30 in the '108 patent). To accomplish the handling of the wafer in a secure and reliable fashion, it is common to equip the end effector with a vacuum arrangement to enable the end effector to removably grasp the wafer. In a typical system, the end effector includes a series of holes (such as apertures 70 in the '108 patent) that are coupled to a vacuum source that may be toggled between states in which it is actuated or released.

Furthermore, in semiconductor metrology, wafer substrates typically must be held in place with a high degree of precision on fixtures, particularly during measurement operations. A popular, traditional method is to clamp a wafer substrate to a chuck by means of an applied vacuum. The chuck is then rotated or moved along linear axes as needed to implement the measurement process. It is generally accepted that this approach to holding the substrate can and often does cause contamination of the surface that is clamped. The risks associated with contamination are exacerbated by recent wafer processing advances that require that the surfaces be highly polished and free of particles. Two likely causes of contamination are the generation of particles when the substrate contacts the chuck and the flow of unclean gas (usually air) generated when the vacuum is released. Because particles are detrimental to subsequent processing of wafer substrates, their generation and proliferation are objectionable and should be minimized. A typical prior art approach for conducting measurements on a wafer may involve steps such as the following:

1. insert end effector into the cassette in which the wafer is located;

2. actuate vacuum arrangement coupled to end effector to grasp the wafer;

3. move the end effector (with wafer) to an alignment station chuck and actuate alignment chuck vacuum to hold down the wafer;

4. turn off end effector vacuum;

5. remove end effector;

6. physically align wafer in alignment chuck;

7. insert end effector beneath the wafer in the alignment chuck;

8. actuate vacuum arrangement coupled to end effector to regrasp the wafer and release alignment chuck vacuum;

9. move wafer to measurement chuck;

10. actuate vacuum on measurement chuck;

11. release end effector vacuum;

12. remove end effector from measurement chuck;

13. run test on wafer on measurement chuck;

14. insert end effector beneath the wafer in the measurement chuck;

15. actuate vacuum arrangement coupled to end effector to regrasp the wafer and release measurement chuck vacuum;

16. return wafer to cassette;

17. release end effector vacuum; and

18. remove end effector from cassette.

An innovation by QC Solutions, Inc., the assignee herein, has somewhat reduced the number of steps involved in wafer testing by eliminating the need for a separate alignment chuck. This innovation provides what we call “virtual alignment” of the wafer on the measurement chuck. The virtual alignment process involves measuring, with a high degree of accuracy, the effective two-dimensional displacement of the wafer's center from the measurement chuck's rotational axis. This displacement measurement is then used to provide appropriate adjustment to the coordinates associated with measurements taken over the surface of the wafer while it sits on the measurement chuck. Using this process, the wafer can be transferred directly from the cassette to the measurement chuck without intermediate use of an alignment chuck.

The use of gas flow in object holders to generate forces essentially orthogonal to the direction of the flow (based upon the Bernoulli principle) is well known in the art. For example, U.S. Pat. No. 6,095,582 to Siniaguine et al., directed to article holders and holding methods, as well as U.S. Pat. No. 4,903,717, U.S. 5,080,549, U.S. 5,967,578, U.S. 5,979,475, and U.S. 6,056,825 disclose such principles and fixturing.

All of the patents referenced in the present application, and the references cited in such patents, are hereby incorporated herein by reference in their entirety.

### SUMMARY OF THE INVENTION

In embodiments of the present invention we have provided an apparatus and method permitting the handling of a wafer while maintaining the vacuum applied to the relevant wafer handling equipment continuously in an actuated state. These embodiments provide more gentle wafer handling with reduced contamination risk.

In one of these embodiments, there is provided a method of handling a semiconductor wafer. The method of this embodiment includes:

placing an end effector beneath the wafer, the end effector having a retaining means for retaining the wafer;

using the end effector to move the wafer and to cause the wafer to rest on a holder;

using air flow toward an actuatable vacuum source to provide a force that retains the wafer against the holder;

removing the end effector from beneath the wafer; and

performing all of the foregoing processes while maintaining the vacuum source continuously in an actuated state so that the air flow is continuous and without changing the state of the retaining means.

In a related embodiment, the retaining means includes a plurality of contact regions mounted on the end effector and in contact with the lower surface of the wafer, for retaining the wafer thereon using gravitational force. Optionally, at each contact region the end effector includes a wedge-shaped lifter, the lifter being disposed so that a region of the periphery lies on the lifter, the wedge being thickest in a direction outward from the periphery. The end effector as described is by itself another embodiment of the invention.

In another related embodiment, the holder includes a plate with a first plate surface having a plurality of support pins protruding therefrom and in contact with the lower surface of the wafer, the plate also having a fluid outlet port in communication with the first plate surface, and wherein the vacuum source is coupled to the fluid outlet port, so that a gap is defined between the first plate surface and the lower surface of the wafer and air flow in the gap between the first plate surface and the lower surface of the wafer provides a force that retains the wafer against the holder.

In a related embodiment, there is provided a method for holding an object, such as a semiconductor wafer. The method of this embodiment includes:

providing a holder, the holder including a plate having a first plate surface, the first plate surface having a plurality of support pins protruding therefrom, the plate having a fluid outlet port in communication with the first plate surface, and wherein a vacuum source is coupled to the fluid outlet port;

resting the first object surface on the support pins so as to define a gap between the first plate surface and the first object surface, so that the fluid outlet port provides fluid communication between the gap and the vacuum source; and

using the vacuum source to move fluid from the gap so as to establish a retentive force on the object.

In related embodiments, (i) a manifold is disposed in the plate and the manifold is in communication with the outlet port; (ii) the plate has a plurality of inlet ports in communication with the manifold and having openings on the first plate surface. Optionally, each inlet port is disposed proximate to a support pin, and the plurality of inlet ports is the same as the plurality of support pins. The method may also include optionally adjusting the flow of fluid through the gap to provide a desired amount of retentive force on the object.

In further related embodiments, the fluid is a gas, such as air. While any object size can be accommodated, optionally, the object is a semiconductor wafer having a diameter that measures approximately 200 mm or 300 mm. Optionally the support pins project above the first plate surface by an amount measuring between approximately 0.1 mm and approximately 3 mm. In further related embodiments, the support pins project above the first plate surface by an amount measuring between approximately 0.3 mm and approximately 0.7 mm, and optionally approximately 0.5 mm. Also in related embodiments, the support pins contain quartz and alternatively or in addition contain an electrically conductive material. Optionally, the plate has at least one additional fluid outlet port providing fluid communication between the gap and the vacuum source; alternatively or in addition, the plate has a fluid port providing fluid communication between a volume exterior to the holder and the gap.

In other related embodiments, there is provided a holder as described in connection with the methods above.

The Bernoulli-type force generated by the fluid flow within the gap effectively holds the object upon the support pins while the pump remains activated. The fluid may be air, in which case air that is removed from the gap may be replaced from the surroundings. The object may be a semiconductor wafer to be held with minimal risk of breakage, warping and contamination. The support pins may contain quartz; the support pins may also contain an electrically conductive material.

In another holder embodiment, the plate may have at least one additional fluid outlet port providing fluid communication between the gap and the pump. In yet another holder embodiment, the plate has another fluid port providing fluid communication between a volume exterior to the holder and the gap. In this embodiment, the holder may further have a filter located between the volume and the gap.

### BRIEF DESCRIPTION OF THE DRAWINGS

FIG. 1 is a cross-sectional view of a holder and a held object in accordance with an embodiment of the present invention.

FIG. 2 is a schematic representation of the Bernoulli-type force, B, generated by the apparatus of FIG. 1.

FIG. 3 is a top view of a plate component of a holder in accordance with an embodiment of the invention.

FIG. 4a is a partial cross-section of the gap associated with a holder embodiment;

FIG. 4b is a partial cross-section of the gap associated with a variation of the holder embodiment of FIG. 4a.

FIG. 5 is a cross-sectional view of another holder embodiment.

FIG. 6 is a longitudinal view of a variation of the holder embodiment of FIG. 5.

FIG. 7 is a cross-sectional view of yet another holder embodiment.

FIG. 8 is a cross-sectional view of a holder in accordance with a further embodiment of the present invention.

FIG. 9 is a view of an end effector 91 in accordance with an embodiment of the present invention shown holding a wafer.

FIG. 10 is a view providing further detail of the end effector of FIG. 9.

FIG. 11 is a view providing detail of the lifter 95 of FIGS. 9 and 10.

FIG. 12 shows embodiment of a holder in accordance with the present invention in which the plate is provided with a manifold.

FIG. 13 shows an embodiment of a holder having an end effector cutout suitable for use with the end effector of FIG. 9.

### DETAILED DESCRIPTION OF SPECIFIC EMBODIMENTS

A holder which, inherently, has less risk of contamination may desirably provide a very small contact area with the held object to minimize particle generation and deposition via direct contact. It should provide adequate force (and friction, in some embodiments) to retain the object on the holder during any required processing. Further, holder operation should tend to minimize the effect of any generated contamination.

Definitions.

As used in this description and the accompanying claims, the following terms shall have the meanings indicated, unless the context otherwise requires:

“Fluid” is any liquid or gas which, by its flow, may generate Bernoulli-type forces essentially orthogonal to the fluid flow.

An “atmospheric” system is one that utilizes air or other gas at a pressure near atmospheric pressure as opposed to a “vacuum process” system.

A “vacuum source” is any arrangement that provides a partial vacuum suitable for causing the exhaust flow of fluid from a region to which the arrangement is coupled. Accordingly, the “vacuum source” may be implemented as a pump that is configured to exhaust fluid from the region.

A “pump” is any device that urges fluid from one location to another. Within the scope of the present disclosure, the pump element of the embodiments of the holder is designed to direct fluid toward itself rather than away from itself. In this context, any contamination associated with the introduction of an operating pump will not tend to affect the object being held. Further, existing contamination proximal to the object or its near surroundings may beneficially be pumped away from the surfaces of the object.

A “plate” is an element of the holder that has a first plate surface. Although the plate, in the various embodiments and in the applications specifically directed toward semiconductor wafer holders, is depicted to be essentially flat, it is understood by one of ordinary skill that a curved or otherwise irregular surface that may, in some geometry, be congruent with a surface of the object to be held will, also, be within the scope of the disclosure. As long as Bernoulli-type forces may be generated within a gap defined by these surfaces, it is deemed that the term “plate” and the plate element of the holder be not limited to essentially flat structures.

The “length” of a support tip protruding from a first plate surface is the distance occupied by the support tip in a direction normal to the first plate surface.

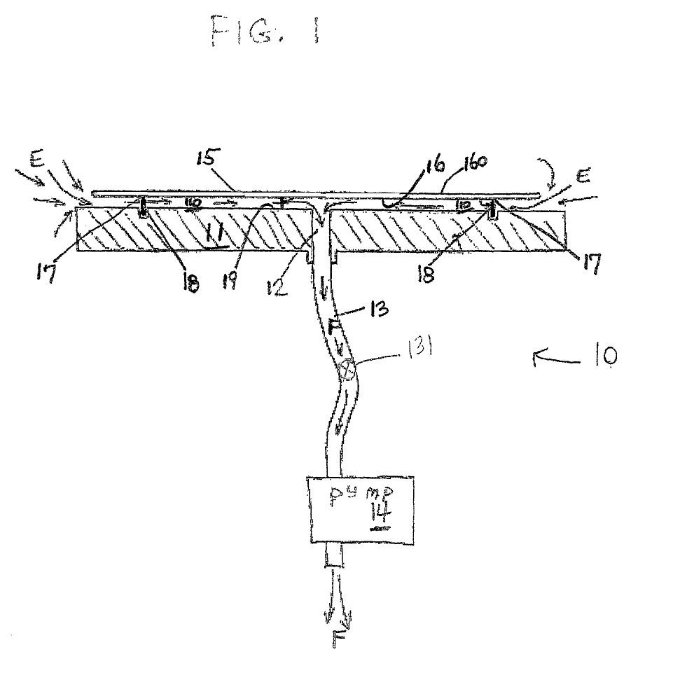

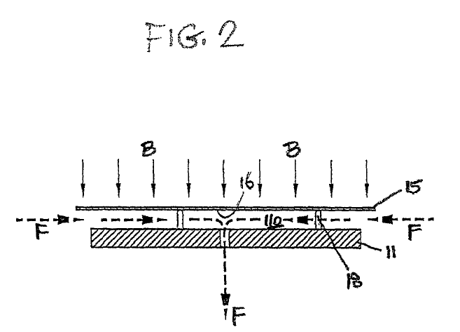

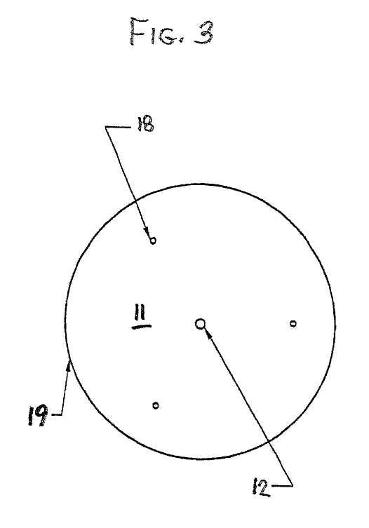

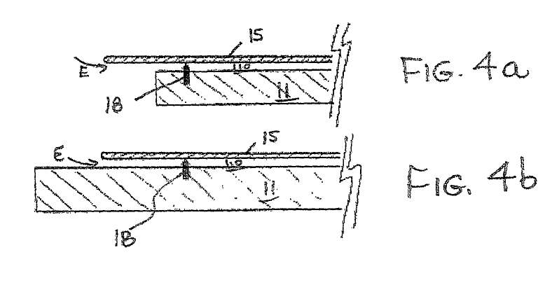

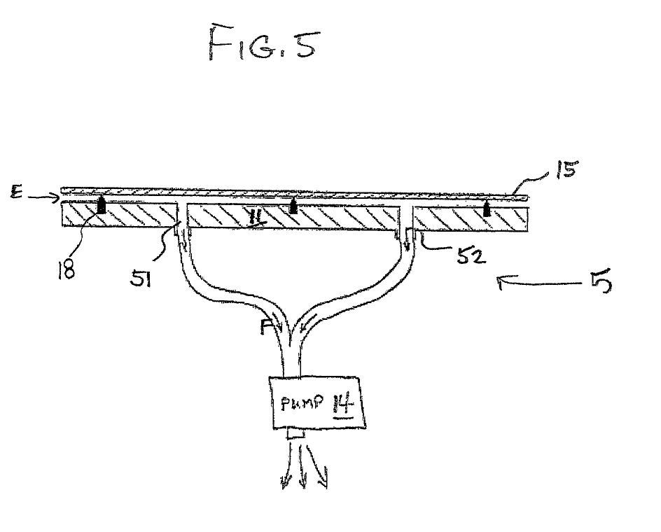

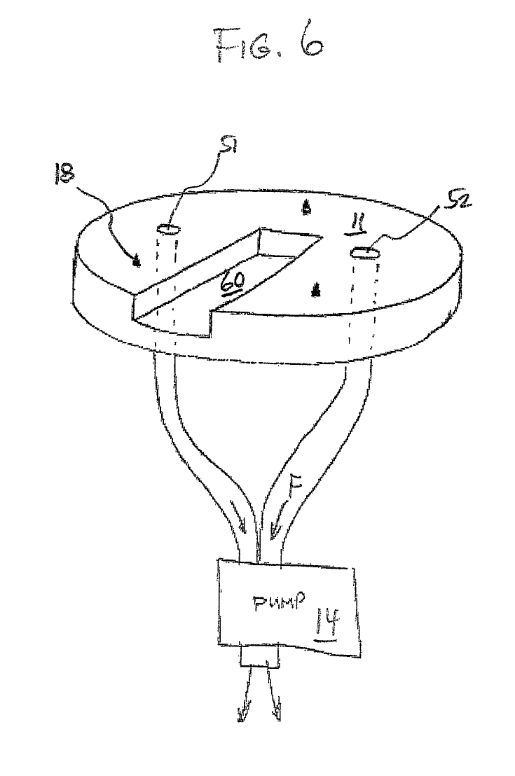

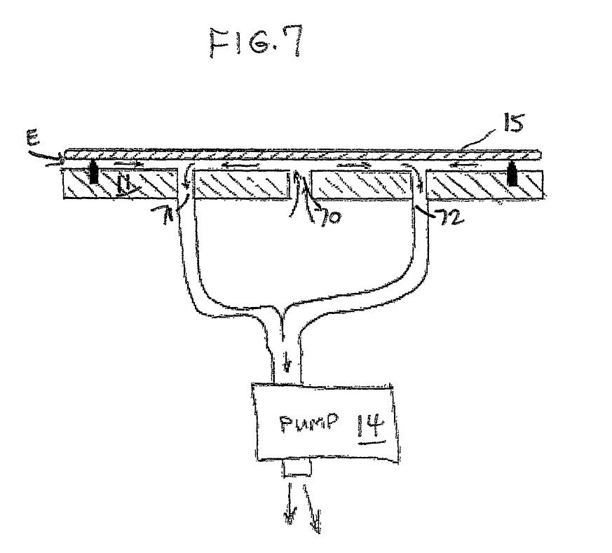

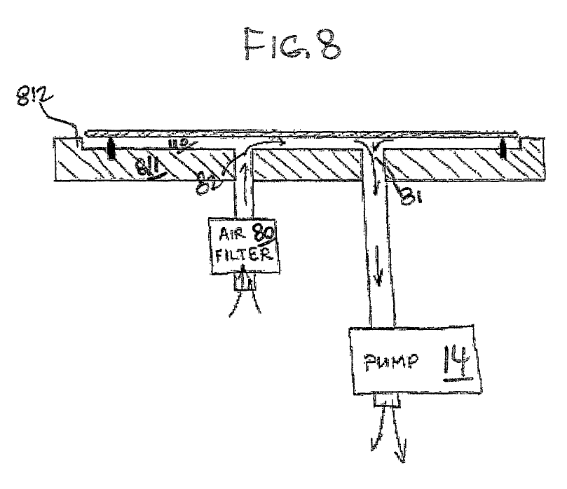

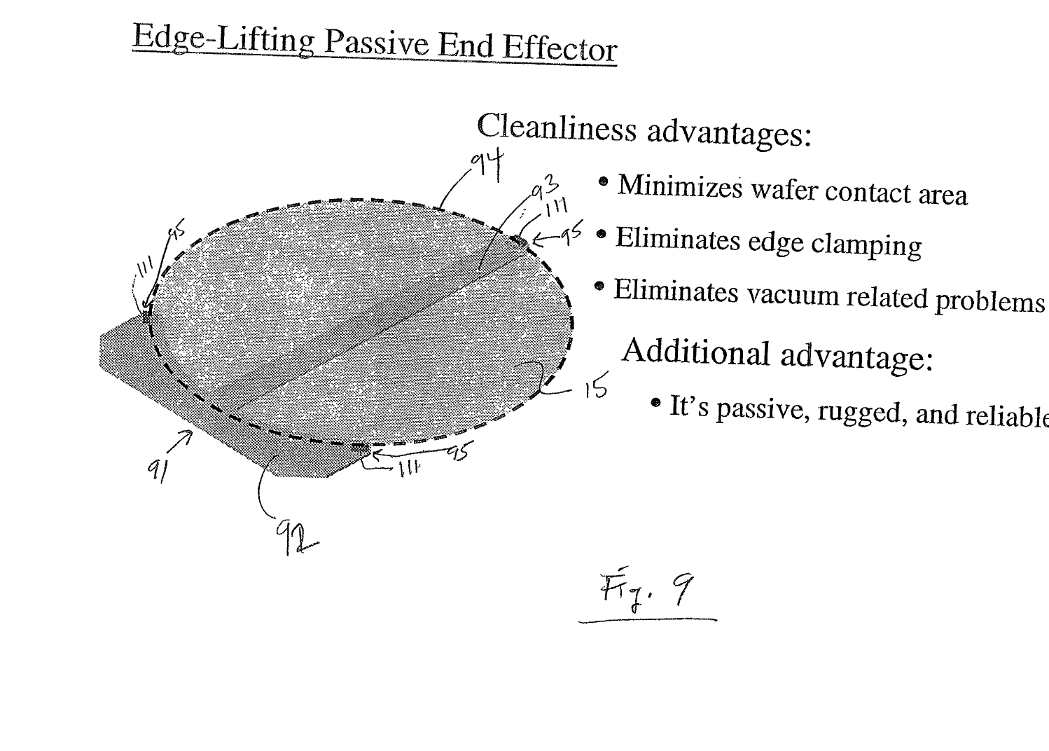

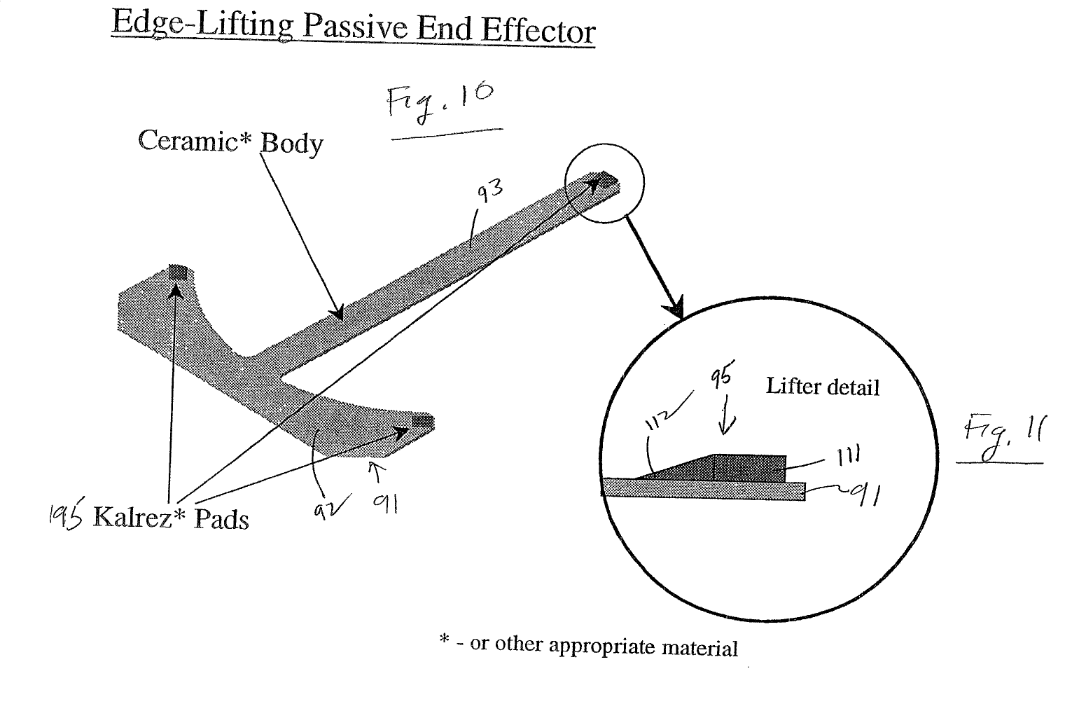

Referring now to FIG. 1, an embodiment of a holder 10 includes a plate 11 having fluid outlet port 12 in fluid communication via hose 13 with pump 14. The object 15 to be held by holder 10 is shown with first object surface 16 touching, at positions 17, support pins 18 that protrude from the first plate surface 19. Although only two support pins 18 are shown in this figure, in fact three support pins are utilized in this embodiment. In other embodiments, such as the embodiment of FIG. 13, four support pins are employed; however, other numbers of support pins may suitably be used under appropriate conditions. Holder 10 may be situated in air, preferably in a clean air environment such as those commonplace in facilities where contamination-sensitive processing takes place. Object 15 may, for example, be a semiconductor wafer having essentially flat primary surfaces requiring a high degree of cleanliness on both first object surface 16 and on opposing surface 160. First plate surface 19 and first object surface 16 define a gap 110 through which air may pass between object 15 and holder 10. Pump 14 functions to generate air flow directed first through the gap 110 adjacent to first object surface 16, then through hose 13 away from object 15, through flow valve 131, and out of gap 110. Refer to arrows F. In this embodiment, air is replenished to the gap 110 from the environment. Refer to arrows E. Air flow adjacent to and essentially parallel to first object surface 16 within gap 110 generates, as schematically illustrated in FIG. 2, Bernoulli-type forces essentially orthogonal to the air flow direction. Refer to arrows B for the direction of these forces, which tend to retain object 15 in place against the support pins 18. The flow of air through the gap 110 between the plate 11 and object 15 (due to the Bernoulli principle) develops force essentially normal to first object surface 16. This force increases the frictional force between object 15 and holder 10, and helps hold the object 15 in place. Fluid flow direction does not need to be reversed during the holding operation, and for this, among other reasons, the embodiment of this figure differs from conventional vacuum clamping methods. Flow valve 131 is used to adjust the air flow through the path described to produce a desired retaining force for given conditions of the gap 110 and object 15.

FIG. 3 is a top view of plate 11. Plate 11 has three support pins 18 protruding from first plate surface 19. Three support pins 18 tend to maintain an approximately constant gap 110 dimension over the first plate surface 19. In this embodiment, fluid outlet port 12 is centrally disposed in plate 11. As stated above, object 15 is depicted as a disk but is in no way limited to that shape. No fluid (air) flow is generated adjacent the opposing surface 160 of the object. Flow generated adjacent first object surface 16 will tend to sweep any loosely held contamination away from the surface 16 rather than, in prior art Bernoulli-type systems, towards surface 16. Most generally, contamination will move away from object 15 and out of holder 10. By way of example, it is common in “atmospheric” semiconductor equipment, to maintain the air in the vicinity of the wafers in a very clean state. It is, therefore, convenient to use this ambient air as the source of clean air because of the complexities involved in providing clean air or gas through a plumbing system. The flow of clean air past the under side of a wafer (surface 16) minimizes or eliminates deposition of new particles and may possibly remove some pre-existing particles. Support pins 18 may be suitably fabricated from a range of materials. In one embodiment, the material for the support pins may be harder than the object support; hence in the case where the object is a semiconductor wafer, the pins may be made of quartz. In addition the support pins may be optionally electrically conductive, to provide an electrical path between the object 15 and the holder. In one implementation, a layer of indium-tin oxide may be formed on the selected hard material. Alternatively, the support pins 18 may be fabricated from a material that is softer than object 15, and where the object is a semiconductor wafer, the support pins may be made of polyetheretherketone (available from Victrex plc, Thornton Cleveleys, Lancashire, UK under the trademark PEEK). Again the support pins may be made electrically conductive. In yet another embodiment, the support pins may be made of the same material as the object. The support pins, which touch surface 16 during operation of holder 10, may also contain electrically conductive material depending upon the application of holder 10. The support pins may be appropriately rounded to minimize contact area with surface 16 while maintaining an acceptable level of localized deformation of both surface 16 and support pins 18 caused by the holding Bernoulli-type forces. The object 15 does not touch first plate surface 19 and is touched only at points 17 during operation. Fluid flow is continuous and is not directed toward the object 15. Plate 11 may be constructed out of a suitable conductive or non-conductive material. In the semiconductor industry, aluminum or structural ceramic are common materials for this purpose.

As an example, the amount of retentive force generated by a holder embodiment of the present invention has been determined in accordance with a procedure as herein described. A conventional chuck (plate 11) was modified by adding 3 holes equally spaced on a 5.563 in. (141 mm) diameter bolt circle. Three quartz pins (support pins 18) were added with a nominal 0.0185 in. (0.47 mm) projection above the surface of the chuck. A chuck insert was added to fill an end-effector cutout disposed in the chuck. Air was drawn through the center of the chuck (fluid outlet port 12) using a pump and flow was adjusted by means of a valve in series with the pump, and measured by a 0-4 SCFM rotameter. The pump used to draw the air was a Gast (Model 2Z866) diaphragm vacuum/air pump. A 200 mm silicon wafer (object 15), polished on one side, was placed (centered) on the chuck. The wafer used weighed 53 g and was approximately 725 micrometers thick.

The lateral force needed to move the wafer sitting on the pins of this horizontally oriented chuck was measured under various conditions and tabulated here:

Retentive lateral force
(grams)

| | @ 0 SCFM | |
|---|---|---|
| | just friction and | |
| Condition | gravity | @ 1 SCFM |
| Polished Side Down | 9.5 | 51.3 |
| Unpolished Side | 13.5 | 93.3 |
| Down | | |

It should be noted that the pins may, in various embodiments in practice, extend away from surface 19 by as little as about 0.1 mm or as much as about 3 mm for a 200 mm or 300 mm semiconductor wafer object to be held.

FIG. 4a illustrates, in an embodiment, object 15 extending radially beyond the radial extent of plate 11; FIG. 4b illustrates plate 11 extending radially beyond the radial extent of object 15. As long as fluid may flow in the direction of arrow E both of these embodiments will result, in operation, in a Bernoulli-type holder described above.

FIG. 5 depicts a further embodiment of a holder 50 having two fluid outlet ports 51 and 52 disposed in plate 11. FIG. 6 is a longitudinal view of the embodiment of FIG. 5 (two outlet ports). It also, for use in conjunction with a robotic end-effector, illustrates plate 11 having an end-effector cutout section 60. FIG. 7 is a cross-sectional view of a holder embodiment with two fluid outlet ports 71 and 72 and a centrally disposed fluid inlet port 70 disposed in plate 11 to provide more air into the gap. Air flow into port 70 occurs by the same mechanism as other air flow entry (via flow in direction of arrow E) replacing air that has been urged out of the gap by pump 14. Pump 14 is not directly forcing fluid toward object 15, unlike prior art system. FIG. 8 is a cross-sectional view of yet another holder embodiment having a single fluid outlet port 81, a fluid inlet port 82, and an in-line air filter 80 to help insure the cleanest of air within gap 110. Plate 811 is shown as having an optional shoulder 812 that may afford, if necessary, proper balancing of flow within gap 110 to provide appropriate holding force across object 15.

Although support pins 18 are shown as separate pins placed into holes provided by plate 11, such support pins 18 may also be integrally or otherwise formed as part of plate 11.

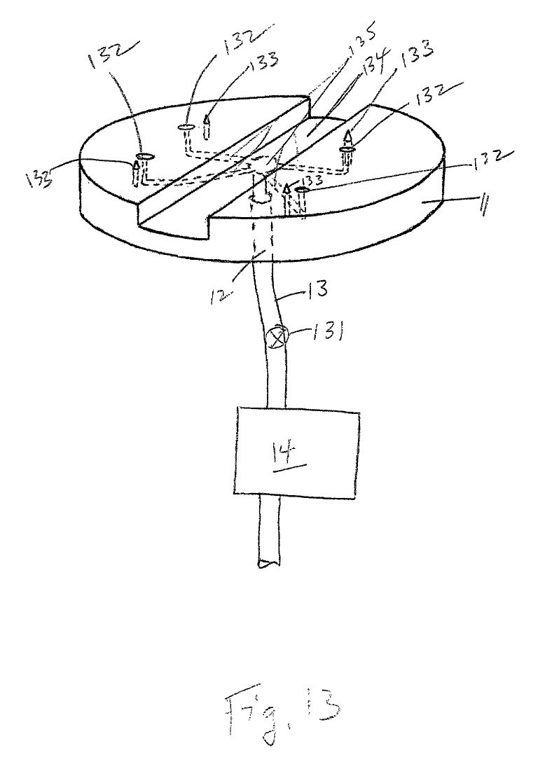

FIG. 12 shows another embodiment of a holder in accordance with the present invention in which the plate 11 is provided with a manifold. In this embodiment, the plate 11 is provided with a manifold 121 in communication with outlet port 12 and a plurality of inlet ports, here identified as inlet port 122 and 123. In this embodiment, support pins 121 are disposed in holes that run through the entire thickness of plate 11 and rest on a table 124, to which the plate 11 is bolted. The benefit of using support pins that rest on the table is that the table is made exceptionally flat, and the support pins can be made of a uniform length, so that they project a uniform amount above the plate 11, when the plate 11 is of uniform thickness; in this fashion a uniform gap 110 may be created between the upper surface 19 of the plate 11 and the lower surface 16 of the object 15.

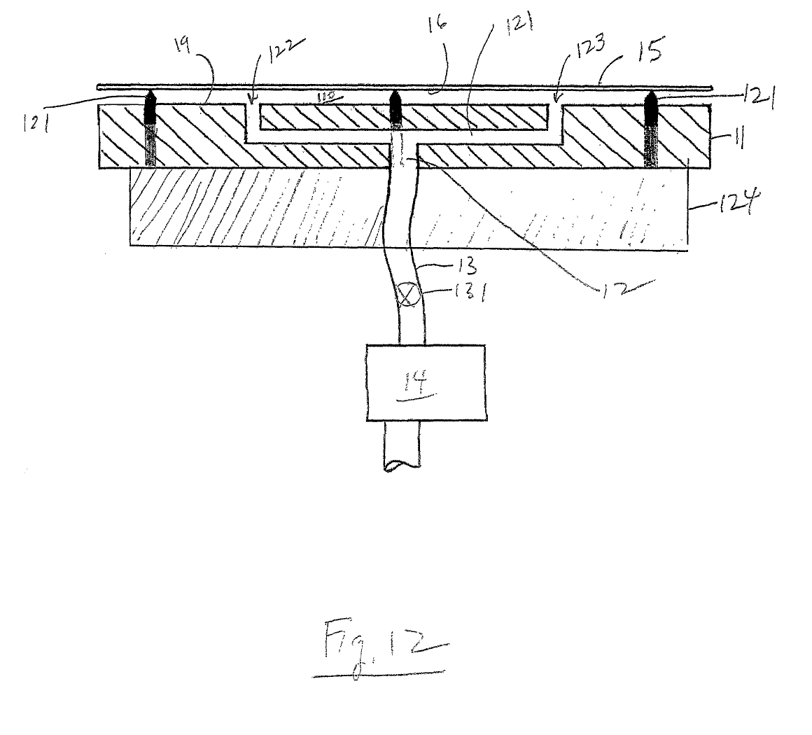

FIG. 9 is a view of an end effector 91 in accordance with an embodiment of the present invention shown holding a semiconductor wafer 15. FIG. 10 is a view providing further detail of the end effector of FIG. 9, and FIG. 11 is a view providing detail of the lifter 95 of FIGS. 9 and 10. As shown in these figures, the end effector 91 has a body that includes a base 92 and a wand 93 extending therefrom. The body may desirably be made of ceramic or other suitable rigid material. The end effector has a plurality of contact regions where it comes in contact with the wafer 15. At each contact region there is located a wedge-shaped lifter 95. The lifter may be made of a suitable material, such PTFE (available from E.I. du Pont de Nemours and Company (“Dupont”) Wilmington, Del., under the trademark TEFLON), polyacetal resin (also available from Dupont, under the trademark DELRIN) or other materials such as perfluoroelastomer (available from DuPont Dow Elastomers L.L.C., Wilmington, Del. under the trademark KALREZ) and polyetheretherketone (available from Victrex plc, Thornton Cleveleys, Lancashire, UK, under the trademark PEEK). Each lifter 95 is disposed so that a region of the periphery of the wafer 15 lies on the lifter. The wedge of each lifter 95 is thickest in a direction outward from the periphery. In other words, the thickest part 111 of the wedge of the lifter lies outside the periphery of the wafer 15. With this configuration of the end effector, gravitational force is used to retain the wafer on the end effector, and the wedge-shaped lifters keep the wafer in a well where the gravitational potential is at a local minimum. In particular, the materials we have identified above are somewhat softer than the wafer they support, and frictional forces between the wafer and the lifter (which are present in part due to gravity) help to retain the wafer in position relative to the body of the end effector. While we have illustrated the use of separate wedge-shaped lifters, a gravitational well for retaining the wafer can be achieved by providing, for example, an end effector body into which the lifters are fully integrated and formed of the same material as the body. Alternatively, the lifters may be partially integrated, so that the wedge shape is achieved by the end effector body, but a different material, such as PTFE, is placed on top at each contact region. Typical dimensions of the lifter when implemented as a separate member are approximately 1 cm wide along a line perpendicular to the radius of the wafer, approximately ½ cm along a radial line, and approximately 2 mm at the thicker end of the wedge. The slope of the wedge may be usefully arranged at approximately 15 degrees.

Using an end effector of the type described in connection with FIGS. 9-11, a wafer may be moved on and off a chuck configured as a holder in the manner of FIG. 1 while the pump is run continuously to provide a force for retaining the wafer on the holder. The end effector needs no vacuum to retain the wafer while moving it, and the end effector can still place the wafer on the chuck and lift the wafer off the chuck while the pump is running. Alternatively or in addition, the end effector may be provided with means for retaining the wafer that does not depend on gravity. For example, the end effector may be provided with its own-Bernoulli-type retaining arrangement in a manner analogous to that shown in connection with FIG. 1 to provide a retaining force in addition to that of gravity.

FIG. 13 shows an embodiment of a holder having an end effector cutout suitable for use with the end effector of FIG. 9. To facilitate insertion and removal of the end effector 91, the end effector cutout 134 here straddles an entire diameter of the plate 11. Four support pins 133 are disposed symmetrically around the plate 11 in a manner leaving the cutout 134 unobstructed. As in the case of FIG. 12, a manifold 135 disposed in the plate 11 is in communication with a plurality of inlet ports 132 and a centrally disposed outlet port 12. Each inlet port 132 is disposed proximate to a support pin 133.

Although the invention has been described with reference to several embodiments, it will be understood by one of ordinary skill in the art that various modifications can be made without departing from the spirit and the scope of the invention as defined by the following claims.

What is claimed is:

1. A method for holding an object, the object having a first object surface, the method comprising:
providing a holder, the holder including a plate with a first plate surface having a plurality of support pins protruding therefrom, the plate also having a fluid outlet port in communication with the first plate surface, and wherein a vacuum source is coupled to the fluid outlet port;
resting the first object surface on the support pins so as to define a gap between the first plate surface and the first object surface, so that the fluid outlet port provides fluid communication between the gap and the vacuum source; and
using the vacuum source to move fluid through the gap so as to establish a retentive force on the object.

2. A method according to claim 1, wherein the fluid is a gas.

3. A method according to claim 2, wherein the fluid is air.

4. A method according to claim 1, wherein the object is a semiconductor wafer having a diameter that measures approximately 200 mm and wherein the support pins project above the first plate surface by an amount measuring between approximately 0.1 mm and approximately 3 mm.

5. A method according to claim 4, wherein the support pins project above the first plate surface by a amount measuring between approximately 0.3 mm and approximately 0.7 mm.

6. A method according to claim 5, wherein the support pins project above the first plate surface by a amount measuring approximately 0.5 mm.

7. A method according to claim 1, wherein the support pins contain a material harder than the object.

8. A method according to claim 7, wherein the material is quartz.

9. A method according to claim 1, wherein the support pins contain a material softer than the object.

10. A method according to claim 9, wherein the material is polyetheretherketone.

11. A method according to claim 7, wherein the support pins contain an electrically conductive material.

12. A method according to claim 1, wherein the plate has at least one additional fluid outlet port providing fluid communication between the gap and the vacuum source.

13. A method according to claim 1, wherein the plate has a fluid port providing fluid communication between a volume exterior to the holder and the gap.

14. A method according to claim 1, wherein: (i) a manifold is disposed in the plate and the manifold is in communication with the outlet port; (ii) the plate has a plurality of inlet ports in communication with the manifold and having openings on the first plate surface.

15. A method according to claim 14, wherein each inlet port is disposed proximate to a support pin.

16. A method according to claim 15, wherein the plurality of inlet ports is the same as the plurality of support pins.

17. A method according to claim 1, further comprising:
adjusting the flow of fluid through the gap to provide a desired amount of retentive force on the object.

18. A holder for holding an object, in combination with the object, the object having a first object surface, the holder comprising:
a plate having a first plate surface, the first plate surface having a plurality of support pins protruding therefrom so that when the first object surface is rested on the support pins there is defined a gap between the first plate surface and the first object surface;
a fluid outlet port, in fluid communication with the first plate surface, for being coupled to a vacuum source, so that, when the first object surface is rested on the support pins, the fluid outlet port provides fluid communication between the gap and the vacuum source, the vacuum source moving fluid through the gap so as to establish a retentive force on the object.

19. A holder according to claim 18, wherein the fluid is a gas.

20. A holder according to claim 19, wherein the fluid is air.

21. A holder according to claim 18, wherein the object is a semiconductor wafer having a diameter that measures approximately 200 mm and wherein the support pins project above the first plate surface by an amount measuring between approximately 0.1 mm and approximately 3 mm.

22. A holder according to claim 21, wherein the support pins project above the first plate surface by an amount measuring between approximately 0.3 mm and approximately 0.7 mm.

23. A holder according to claim 22, wherein the support pins project above the first plate surface by an amount measuring approximately 0.5 mm.

24. A holder according to claim 18, wherein the support pins contain quartz.

25. A holder according to claim 18, wherein the support pins contain polyetheretherketone.

26. A holder according to claim 18, wherein the support pins contain an electrically conductive material.

27. A holder according to claim 18, wherein the plate has at least one additional fluid outlet port providing fluid communication between the gap and the vacuum source.

28. A holder according to claim 18, wherein the plate has a fluid port providing fluid communication between a volume exterior to the holder and the gap.

29. A holder according to claim 28, further comprising a filter located between the volume and the gap.

30. A holder according to claim 18, further comprising:
a flow valve disposed between the vacuum source and the outlet port to permit adjustment of flow of fluid through the gap and therefore of the retentive force on the object.

31. A holder according to claim 18, wherein: (i) a manifold is disposed in the plate and the manifold is in communication with the outlet port; (ii) the plate has a plurality of inlet ports in communication with the manifold and having openings on the first plate surface.

32. A holder according to claim 31, wherein each inlet port is disposed proximate to a support pin.

33. A holder according to claim 32, wherein the plurality of inlet ports is the same as the plurality of support pins.

34. A method of handling a semiconductor wafer, the method comprising:
placing an end effector beneath the wafer, the end effector having a retaining means for retaining the wafer;
using the end effector to move the wafer and to cause the wafer to rest on a holder;
using air flow toward an actuatable vacuum source to provide a force that retains the wafer against the holder;
removing the end effector from beneath the wafer; and
performing all of the foregoing processes while maintaining the vacuum source continuously in an actuated state so that the air flow is continuous and without changing the state of the retaining means.

35. A method according to claim 34, wherein the wafer has a lower surface and the retaining means includes a plurality of contact regions mounted on the end effector and in contact with the lower surface of the wafer, for retaining the wafer thereon using gravitational force.

36. A method according to claim 35, wherein the wafer has a periphery and at each contact region the end effector includes a wedge-shaped lifter, the lifter being disposed so that a region of the periphery lies on the lifter, the wedge being thickest in a direction outward from the periphery.

37. A method according to claim 34, wherein:
the wafer has a lower surface; and
the holder includes a plate with a first plate surface having a plurality of support pins protruding therefrom and in contact with the lower surface of the wafer, the plate also having a fluid outlet port in communication with the first plate surface, and wherein the vacuum source is coupled to the fluid outlet port,
so that a gap is defined between the first plate surface and the lower surface of the wafer and air flow in the gap between the first plate surface and the lower surface of the wafer provides a force that retains the wafer against the holder.

38. A method according to claim 35, wherein:
the wafer has a lower surface; and
the holder includes a plate with a first plate surface having a plurality of support pins protruding therefrom and in contact with the lower surface of the wafer, the plate also having a fluid outlet port in communication with the first plate surface, and wherein the vacuum source is coupled to the fluid outlet port,
so that a gap is defined between the first plate surface and the lower surface of the wafer and air flow in the gap between the first plate surface and the lower surface of the wafer provides a force that retains the wafer against the holder.

39. A method of handling a semiconductor wafer, the wafer having a lower surface, the method comprising:
placing beneath the wafer an end effector, the end effector having plurality of contact regions in contact with the lower surface of the wafer for retaining the wafer thereon using gravitational force;
using the end effector to move the wafer and to cause the wafer to rest on a holder, the holder including a plate with a first plate surface having a plurality of support pins protruding therefrom and in contact with the lower surface of the wafer, so that a gap is defined between the first plate surface and the lower surface of the wafer;
using air flow toward an actuatable vacuum source to maintain fluid flow in the gap between the first plate surface and the lower surface of the wafer to provide a force that retains the wafer against the holder;
removing the end effector from beneath the wafer; and
performing all of the foregoing processes while maintaining the vacuum source continuously in an actuated state so that the air flow is continuous.

40. An end effector for moving a semiconductor wafer, the wafer having a lower surface and a periphery, the end effector comprising:
a base and a wand extending therefrom, the base and the wand collectively having a plurality of contact regions for contacting the lower surface of the wafer, at each contact region there being located a wedge-shaped lifter, the lifter being disposed so that a region of the periphery lies on the lifter, the wedge being thickest in a direction outward from the periphery, so that the wafer is retained thereon using gravitational force.
